(19) United States
(12) Patent Application Publication
(10) Pub. No.: US 2007/0075983 A1
(43) Pub. Date: Apr. 5, 2007

(54) Method for gesture detection on a touchpad

(76) Inventors: Yen-Chang Chiu, Linkou Township (TW); Kuan-Chun Tang, Toufen Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/528,513

(22) Filed: Sep. 28, 2006

(30) Foreign Application Priority Data
Oct. 4, 2005 (TW) 094134722

(51) Int. Cl. G09G 5/00

(52) U.S. Cl. 345/173

(57) ABSTRACT

A multi-function touchpad has a first button located at substantially a center of the touchpad and a second button at substantially an edge of the touchpad. When the first button is pressed, if the second button is also pressed, the touchpad triggers the function in response to the first button and ignores the pressing of the second button.

### FIELD OF THE INVENTION

The present invention is related generally to a touchpad and, more particularly, to a multi-function touchpad.

### BACKGROUND OF THE INVENTION

Touchpad has been widely used in various electronic products to replace the conventional input apparatus due to its simple construction, light weight and low-cost. Currently, there are two types of touchpads, one for one-dimensional mode and the other for two-dimensional mode. FIGS. 1 and 2 show two typical sensors 100 for two-dimensional touchpad, which have a plurality of horizontal traces 102 and vertical traces 104 arranged in a matrix manner. When a finger touches on the two-dimensional touchpad 100, the traces 102 and 104 at the touched position will produce a signal to provide the information of the coordinate of the touched position for a host connected with the two-dimensional touchpad 100. When a finger moves on the two-dimensional touchpad 100, the host could determine the moving direction according to the coordinate difference in the movement and respond to this operation.

However, when a user intends to slide his finger in horizontal or vertical direction, a two-dimensional touchpad may not determine the operation precisely. As shown in FIG. 3 for example, when a user intends to scroll a scroll bar on a window rightward, his finger 106 will move from left to right on the two-dimensional touchpad 105, while during the movement, the finger 106 might deviate upward or downward and thus cause an upward or a downward scrolling along with the rightward scrolling.

On the other hand, U.S. Pat. Publication No. 2004/0252109 discloses a one-dimensional touchpad sensor, which may produce a corresponding response, such as up/down, left/right, and add/subtract, by sensing the movement of a finger as rotating clockwise or counterclockwise on the touchpad. Thus an irregular rotating degree will not affect the judgment to the operation. Though this one-dimensional touchpad is capable of determining the direction as plus or minus exactly, it cannot provide multiple functions such as handwriting recognition, as a two-dimensional touchpad does. If any extra function is required, an extra button or other input device has to be added and thus increases the cost of the hardware.

FIGS. 4 and 5 are the front and rear views of an input apparatus 108 currently used on ipod, which employs a one-dimensional sensor 110 as disclosed in U.S. Pat. Publication No. 2004/0252109. When a finger rotates clockwise or counterclockwise on the circular sensor 110, it is capable of scrolling the list or to adjust the volume. There are further buttons 112 and 114 at the top, bottom, left, right, and center positions of the sensor 110 to provide extra functions, such as start/stop, forward/backward, list and enter. Since the sensor 110 has a circular shape, the central button 112 is alone and could not be as a whole with the sensor 110 in hardware. As shown in FIG. 6, if the sensor 110 is made of a complete circular body, when the center button 112 is pressed, the sensor 110 will have a concave due to the pressure of the finger, and if the pressed position has a departure from the center position, there is a good possibility that the button 114 is pressed by mistake, and thus causes a wrong response.

Thus, it is desired a multi-function touchpad supporting one-dimensional and two-dimensional operational modes and integrated with buttons as a whole.

### SUMMARY OF THE INVENTION

Accordingly, an object of the present invention is to provide a multi-function touchpad which is capable of supporting one-dimensional and two-dimensional operational modes and integrated with buttons as a monocoque.

In a multi-function touchpad according to the present invention, a touch-sense apparatus is capable of supporting one-dimensional and two-dimensional operational modes such that the touchpad can be operated under the one-dimensional or the two-dimensional operational modes, a first button located at substantially the center of the touchpad, and at least one second button located at substantially the edge of the touchpad. When the first button is sensed to be pressed, and the at least one second button is also sensed to be pressed, the touchpad triggers the function in response to the first button and ignores the pressed one or ones of the at least one second button.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIGS. 1 and 2 show two typical sensors for two-dimensional touchpad;

FIG. 3 shows a diagram of a finger moving on a two-dimensional touchpad;

FIGS. 4 and 5 are the front and rear views of an input apparatus currently used on iPod;

FIG. 6 shows a cross-sectional view of the input apparatus shown in FIG. 5 when its center button is pressed;

FIG. 7 shows a block diagram of a first embodiment according to the present invention;

FIG. 8 shows a front view of a touch-sense apparatus according to the present invention;

FIG. 9 shows an operational illustration of a touch-sense apparatus according to the present invention in one-dimensional operational mode;

FIG. 10 shows a block diagram of a second embodiment according to the present invention;

FIG. 11 is a rear view of the sensor of a touchpad according to the present invention;

FIG. 12 shows a timing diagram for the buttons shown in FIG. 11; and

FIGS. 13 and 14 show the front and rear views of a sensor in another embodiment according to the present invention.

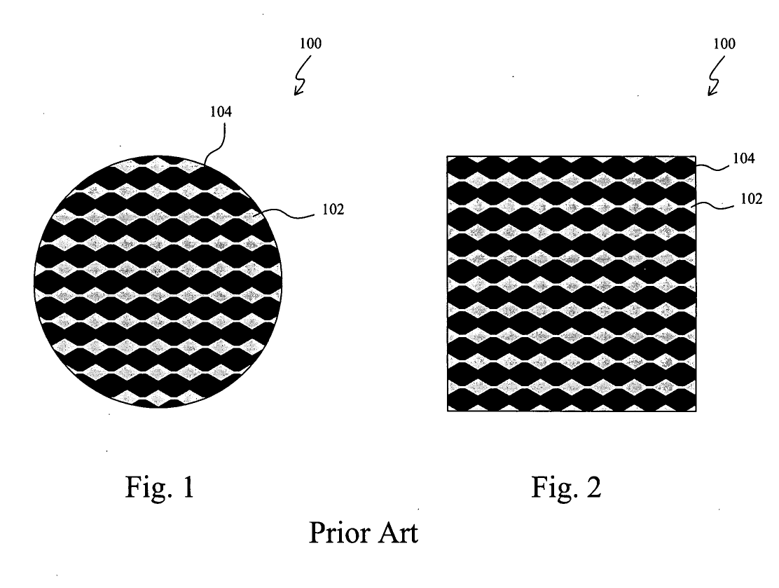

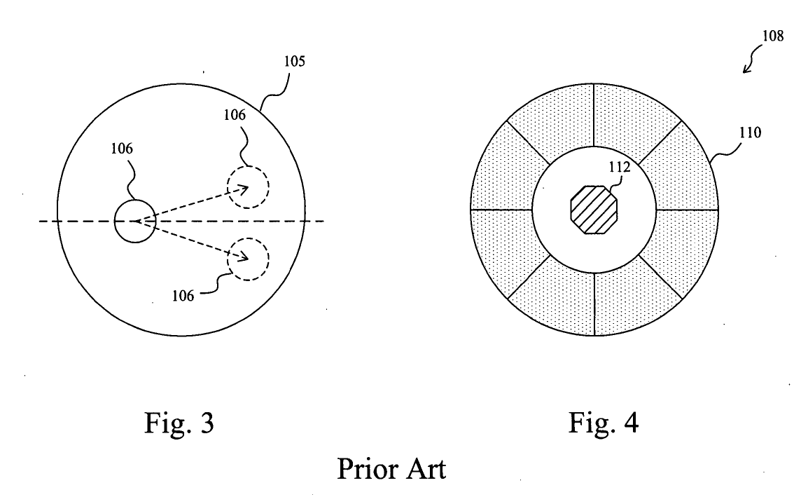

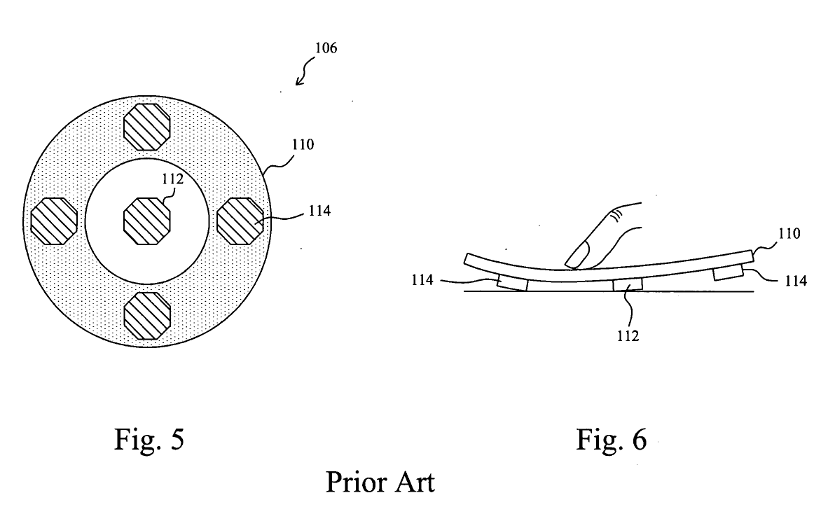

### DETAILED DESCRIPTION OF THE INVENTION

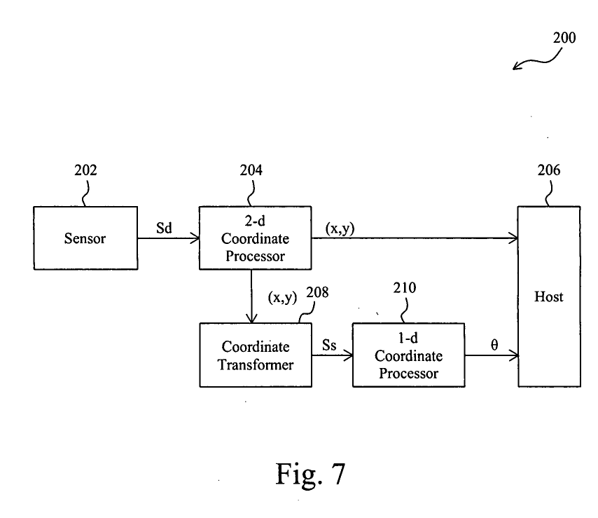

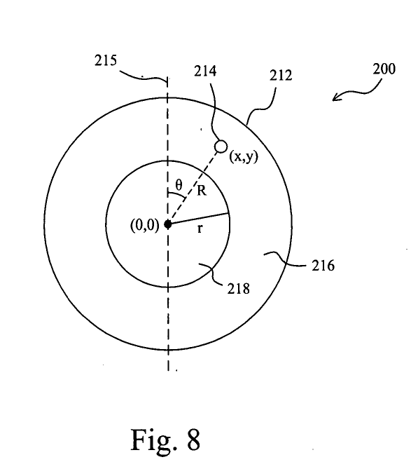

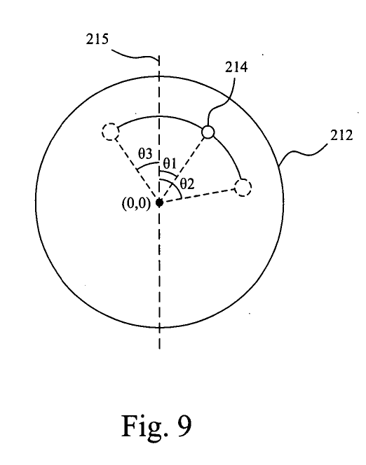

FIG. 7 is a block diagram of a touch-sense apparatus 200 capable of supporting one-dimensional and the two-dimensional operational modes, and FIG. 8 is an operation illustration. When a finger 214 touches the panel 212 of the touchpad, in the touch-sense apparatus 200, a sensor 202 detects the position of the finger 214 on the panel 212 and thereby produces a two-dimensional signal Sd to a two-dimensional coordinate processor 204 to generate a two-dimensional coordinate (x,y). Under the two-dimensional operational modes, the two-dimensional coordinate (x,y) is directly sent to a host 206, and thus the host 206 obtains the current position of the finger 214. When the finger 214 further moves on the panel 212, the two-dimensional coordinate processor 204 sends the coordinate difference to the host 206, such that a corresponding response is generated in response to the movement of the finger 214. Under the one-dimensional operational mode, the two-dimensional coordinate (x,y) is transferred to a coordinate transformer 208 to transfer to a one-dimensional signal Ss, and a one-dimensional coordinate processor 210 generates a one-dimensional coordinate θ according to the one-dimensional signal Ss to the host 206. In this embodiment, the one-dimensional coordinate θ is the angle between the finger 214 and the centerline 215. As shown in FIG. 9, when the finger 214 further moves on the panel 212, the one-dimensional coordinate θ is changed accordingly, and the one-dimensional coordinate processor 210 sends the coordinate difference to the host 206, such that it can determine the movement of the finger 214 as clockwise or counterclockwise and generate a corresponding response. The touchpad of the present invention supports the one-dimensional and the two-dimensional operational modes, and thus has the advantages of both therefrom. Users can choose the one-dimensional or the two-dimensional operational mode according to their needs.

The control method for mode switch can be achieved by defining the position of the finger 214 on the panel 212 as the one-dimensional or the two-dimensional operational mode. For example, as shown in FIG. 8, the panel 212 is defined with an exterior region 216 and an interior region 218. When the finger 214 falls on a position within the exterior region 216, the touch-sense apparatus 200 enters the one-dimensional operational mode. When the finger 214 falls on a position within the interior region 218, the touch-sense apparatus 200 enters the two-dimensional operational mode. In this embodiment, because the exterior region 216 and the interior region 218 are concentric circles, the center of the circle can be set as the original point (0,0) of a coordinate system. If the coordinate of the finger 214 on the panel 212 is (x,y), the distance between the finger 214 and the center of the circle (0,0) can be obtained according to the radius equation
R=\sqrt{x²+y²} [Eq-1]
Furthermore, if the radius of the interior region 218 is r, it is then determined that, when R is greater than r, the finger 214 falls in the exterior region 216, and when R is less than r, the finger 214 falls in the interior region 218. In some other embodiments, the panel 212 is defined with two or more regions. In yet some other embodiments, the shapes of the defined regions on the panel 212 are irregular. The shape of the panel 212 is not limited to circle, and other geometric shapes such as rectangular, triangle and other irregular shapes are also applicable.

The number of the fingers on the panel 212 may be also used to switch between the one-dimensional and two-dimensional operational modes. For example, when there is only one finger falling on the panel 212, the touch-sense apparatus 200 will switch to operate under the two-dimensional operational mode, and when there are two fingers falling on the panel 212, the touch-sense apparatus 200 will switch to operate under the one-dimensional operational mode. Otherwise, other gesture may also be used to switch between the operational modes. For example, a double click of the finger on the panel 212 is to switch the operational mode.

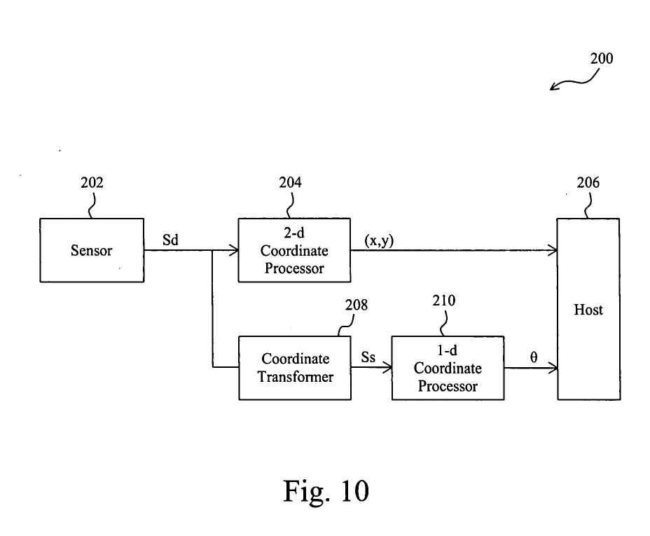

FIG. 10 shows a block diagram of another touch-sense apparatus 200 to support one-dimensional and two-dimensional operational modes. The elements in this embodiment are the same as in FIG. 7, while the signal Sd produced by the sensor 202 is directly connected to the coordinate transformer 208. When the finger 214 touches the panel 212 of the touch-sense apparatus 200, the sensor 202 detects the position of the finger 214 to produce the two-dimensional signal Sd to both the two-dimensional coordinate processor 204 and the coordinate transformer 208. The two-dimensional coordinate processor 204 generates the two-dimensional coordinate (x,y) to the host 206 according to the two-dimensional signal Sd, and the coordinate transformer 208 transforms the two-dimensional signal Sd to the one-dimensional signal Ss to the one-dimensional coordinate processor 210 to generate the one-dimensional coordinate θ to the host 206. The host 206 may automatically determine which coordinate, the two-dimensional coordinate (x,y) or the one-dimensional coordinate θ, is used.

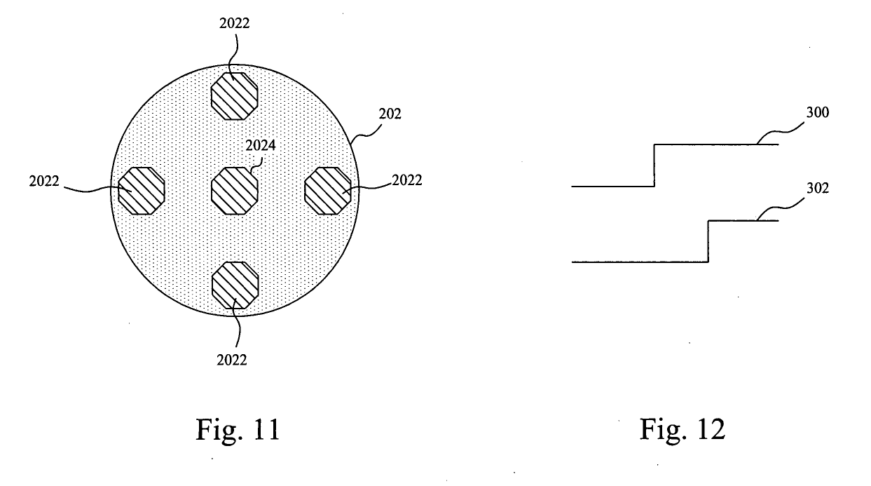

FIG. 11 is a rear illustration of the sensor 202 of a touchpad according to the present invention, which has 5 buttons 2022 and 2024 on the sensor 202. The buttons 2022 are disposed on the up, down, left and right edges of the sensor 202, and the button 2024 is located on the center of the sensor 202. When any one of the buttons 2022 is pressed by mistake due to the departure from the center position during pressing the center button 2024, a software or a firmware algorithm can be used to trigger the function in response to the button 2024 and to ignore the pressing of the button 2022. FIG. 12 shows a timing diagram for the buttons 2022 and 2024 in FIG. 11, in which waveform 300 represents the signal produced by pressing the button 2024 and waveform 302 represents signal produced by pressing the button 2022. When a user presses the center button 2024, which will trigger the signal 300 to transit from logical low to logical high, if the pressed position deviates from the center so as to press the button 2022, the signal 302 will be also triggered to transit from logical low to logical high. In this case, a predetermined algorithm will perform the function in response to the button 2024 because the signal 300 is triggered first, and the pressing of the button 2022 will be ignored to prevent unexpected operations.

Since an algorithm is used to prevent the wrong operation due to the wrong pressing of the button 2022 resulted from the concave of the sensor 202 when the center button 2024 is pressed, the touchpad being as a whole is achieved after integrating the buttons 2022 and 2024.

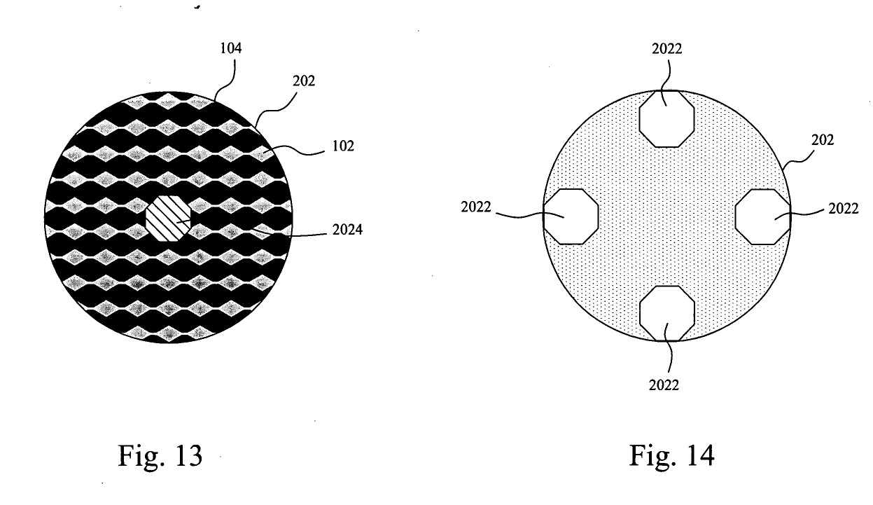

FIGS. 13 and 14 show another embodiment of the button integration according to the present invention, in which FIG. 13 shows the front view of the sensor 202 and FIG. 14 shows the rear view of the sensor 202. Referring to FIGS. 13 and 14, there are horizontal traces 102 and vertical traces 104 on the front side of the sensor 202 with the button 2024 located at the center, and 4 buttons 2022 located at the four edges of the top, down, left and right positions on the back side of the sensor 202. In this embodiment, since the center button 2024 is located at a different surface from that of the other 4 buttons 2022, when pressing the center button 2024, a departure of the pressed position from the center will not trigger the button 2022 by mistake.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A multi-function touchpad comprising:
a touch-sense apparatus being capable of supporting a one-dimensional operational mode and a two-dimensional operational mode;
a first button located at substantially a center of the touchpad; and
a second button located at substantially an edge of the touchpad.

2. The touchpad of claim 1, wherein the touchpad triggers a function in response to the first button and ignores a pressing of the second button if the second button is also pressed when the first button is pressed.

3. The touchpad of claim 1, wherein the touch-sense apparatus comprises:
a sensor having a first group of traces in a first direction and a second group of traces in a second direction, for detecting a position of an object on the touchpad to generate a first signal;
a two-dimensional coordinate processor for generating a two-dimensional coordinate according to the first signal in the two-dimensional operational mode;
a coordinate transformer for generating a second signal according to the first signal or the two-dimensional coordinate in the one-dimensional operational mode; and
a one-dimensional coordinate processor for generating a one-dimensional coordinate according to the second signal.

4. The touchpad of claim 2, wherein the first and second buttons are located at a same side of the sensor.

5. The touchpad of claim 1, wherein the first button is located at a first side of the sensor, and the second button is located at a second side of the sensor.

6. A control method for a multi-function touchpad having a first button located at substantially a center of the touchpad and a second button at substantially an edge of the touchpad, the method comprising the steps of:
detecting whether or not an object touching or pressing the touchpad; and
triggering a function in response to the first button and ignoring a pressing of the second button if the second button is also pressed when the first button is pressed.

7. The method of claim 6, further comprising the steps of:
detecting a position of the object for generating a first signal if the object is detected to touch the touchpad;
in a two-dimensional operational mode, generating a two-dimensional coordinate according to the first signal; and
in a one-dimensional operational mode, generating a second signal according to the first signal or the two-dimensional coordinate and further generating a one-dimensional coordinate according to the second signal.
